(19) United States
(12) Patent Application Publication
(10) Pub. No.: US 2010/0136983 A1
(43) Pub. Date: Jun. 3, 2010

(54) METHOD OF USING AVAILABLE MOBILE COMMUNICATION TERMINAL AS RELAY STATION

(75) Inventors: Biao LU, NANJING (CN); Zhong-Tao HAO, NANJING (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/325,143

(22) Filed: Nov. 29, 2008

(51) Int. Cl. H04W 40/00; H04B 3/36

(52) U.S. Cl. 455/446; 455/7

(57) ABSTRACT

A method of using an available mobile communication terminal as a relay station is applied to base stations (BS) and mobile communication terminals, and each mobile communication terminal can function as a relay station. When a mobile communication terminal performs communication and signals received from a base station are in a state of being weak, a relay request is sent to the base station to search for available mobile communication terminals having communication signals stronger than the signals learned to be weak within a coverage area of the base station which sends out a notice message. After receiving the notice message, an available mobile communication terminal is selected as a relay station, and a register request is sent to the relay station for connecting to the mobile communication terminal. Upon accepting the register request, the mobile communication terminal can be connected to the base station through the relay station.

### BACKGROUND

1. Field of Invention

The present invention relates to a communication method of a mobile communication terminal. More particularly, the present invention relates to a method of using another available mobile communication terminal (i.e. not in a communication state) as a relay station when a mobile communication terminal learns that signals received from a base station are in a state of being weak, thereby establishing a connection between the mobile communication terminal and the base station through the relay station for making phone calls.

2. Description of Related Art

With the advent of daily new communication technologies and high-quality low-price mobile phones, mobile phones have become widely popular in use. Mobile phones not only bring quite a lot of convenience to human's work and living, but also effectively satisfy human's various needs by adding many aesthetic and functional designs on the mobile phone appearance from manufactures based on the trend of popularity of the mobile phones. Hence, nowadays, mobile phones have become important communication tools carried by people at almost any time. Whenever being out of town or out of country, people often carry mobile phones for meeting the unexpected needs. Therefore, a mobile phone not only is a communication tool bringing living convenience, but also has become an accessory symbolizing a social status. Further, with the rapid development of GSM (Global System for Mobile Communications) technology, government agencies and communication venders spend a great effort to promote GSM mobile phones, thereby grapping a mobile communication market share by taking advantage of the low cost and fare of the GSM mobile phones. Also, the GSM mobile phones indeed bring more convenience to the society.

The GSM technology employs a cell network, i.e. a mobile phone is first connected to a base station, and then the base station searches for a cell zone nearest to the mobile phone, thereby connecting to another mobile phone. Since the GSM network may be operated at several different frequencies, its coverage area is different with different environments. Generally speaking, the GSM cell network can be divided into four different cell units including:

1. a macro cell, which can be considered as a base station antenna mounted on an antenna pole or a building's rooftop;

2. a micro cell, which can be considered as an antenna of which the height is lower than that of the micro cell, and is commonly used in a city area;

3. a picocell, which is a small cell only covering the range up to tens meters; and

4. an umbrella cell, which is used to cover the even smaller blind zones to cell networks (i.e. no-signal areas among cell networks), thereby filling the signal blank spots among cells;

The cell network has a coverage range composed of the aforementioned cell units. Although it appears that the cell network may cover all of the areas without missing any spot, yet the following problems still exist on the actual applications of mobile phones and cell networks.

1. A blind zone exists in the cell network due to the leakage of network coverage, or weak signals caused by the obstacles blocking electric waves in propagation, thus resulting in poor communication quality greatly affecting users in telephone connections.

2. A hot spot exists in the cell because the load is not evenly distributed on the respective base stations and thus a certain base station is particularly busy. For example, when a multitude of users are crowded in a busy area such as a business center, a heavy traffic path, a new-year party, etc. When a plurality of GSM mobile phones are simultaneously connected to a same base to station in this busy area, the GSM mobile phones simultaneously send out signals to the same base station. While receiving these signals, the base station cannot handle the signals within a short period of time. At this point, the base station is in a jamming state, and busy signals or no-service signals are displayed on the GSM mobile phones respectively, and thus the users cannot make phone calls, thus causing a lot of inconvenience.

Besides, when the GSM mobile phones sends signals to the base station, the signals are put in a queue to be processed by the base station, and then the base station sends the signals in sequence to the corresponding GSM mobile phones. Meanwhile, if the corresponding GSM mobile phones are shut down or located beyond the service area and thus the base station cannot deliver the signals thereto, the base station has to temporarily store the signals and then send the signals again to the corresponding GSM mobile phones. The base station will prepare buffer areas for the respective GSM mobile phone, but each buffer area has a capacity limit. If a buffer area is full of signals, the base station cannot receive any new signal sent from the GSM mobile phone corresponding to the buffer area, thus causing the GSM mobile phone to fail to make phone calls normally, and meanwhile, the signals in the base station will in a jamming state which generally results in signal loss, so that the base station cannot handle a great amount of signals within a short period of time.

To sum up, there still is much room for improvement on the quality of signal and phone connection for the cell network and the mobile phones. Hence, how to design a mobile phone communication method for effectively improve the overall phone call quality in the existing mobile phone environment and also resolving the problem of failing to connect the mobile phones to the base station when the network is crowded, has become a major topic for mobile phone communication providers to endeavor and research.

### SUMMARY

In view of the aforementioned shortcomings, according to technical experience and professional knowledge spanning many years, the present invention provides a method of using an available mobile communication terminal as a relay station for effectively resolving the problems of unstable connection or connection failure between mobile communication terminals and base stations.

An object of the present invention is to provide a method of using an available mobile communication terminal as a relay station. The method is applied to a plurality of base stations (BS) and a plurality of mobile communication terminals (in such as GSM or PHS), wherein each of the mobile communication terminals has a function of acting as a relay station. When a mobile communication terminal performs communication and learns that signals received from a first base station are in a state of being weak, the mobile communication terminal sends a relay request to the first base station, and requests the first base station to search for at least one other available mobile communication terminal (i.e. not in a communication state) having communication signals stronger than the signals learned to be weak within a coverage area of the first base station and to send out a notice message. After the mobile communication terminal receives the notice message from the first base station, another available mobile communication terminal is automatically selected as a first relay station within the coverage area of the first base station, to and a register request is sent to the first relay station for connecting the first relay station to the mobile communication terminal. After the first relay station accepts the register request from the mobile communication terminal, the mobile communication terminal can be used to perform communication without being affected by a geographic terrain obstacle by connecting to the first base is station through the first relay station, thereby effectively overcoming the situation of having an unstable connection or unable to connect the mobile communication terminal with the first base station when the mobile communication terminal performs communication and learns that the signals received from the first base station are in a state of being weak.

Regarding another object of the present invention, when the first relay station receives or make phone calls, the first relay station sends a disconnection message to the mobile communication terminal. Meanwhile, the mobile communication terminal automatically selects a next available mobile communication terminal having stronger communication signals as a second relay station within the coverage area of the first base station, thereby connecting to the first base station through the second relay station for making phone calls, thus resolving the problem of the mobile communication terminal interruption caused by the first relay station receiving or making phone calls.

Regarding another object of the present invention, when the mobile communication terminal performs communication, and finds that the first base has reached a maximum communication load and thus cannot connect to the first base station through the first relay station, the first relay station searches for at least one other available base station. After the first relay station receives messages from the at least one other available base station, a second to base station having stronger communication signals is automatically selected therefrom. Meanwhile, the first relay station is disconnected from the first base station, and the mobile communication terminal is connected to the second base station through the first relay station, thereby receiving or making phone calls.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing the signals transmitted among a mobile communication terminal, a first relay station and a first base station according to an embodiment of the present invention;

FIG. 2 is a schematic diagram showing the signals transmitted among the mobile communication terminal, the first relay station, a second relay station and the first base station according to an embodiment of the present invention;

FIG. 3 is a schematic diagram showing the structures of the components used in an embodiment of the present invention;

FIG. 4 is a schematic flow chart showing the steps of Using an available mobile communication terminal as the first relay station according to an embodiment of the present invention;

FIG. 5 is a schematic flow chart showing the steps of connecting the to mobile communication terminal to the second relay station according to an embodiment of the present invention; and

FIG. 6 is a schematic diagram showing the signals transmitted among the mobile communication terminal, the first relay station, the first base station and a second base station according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

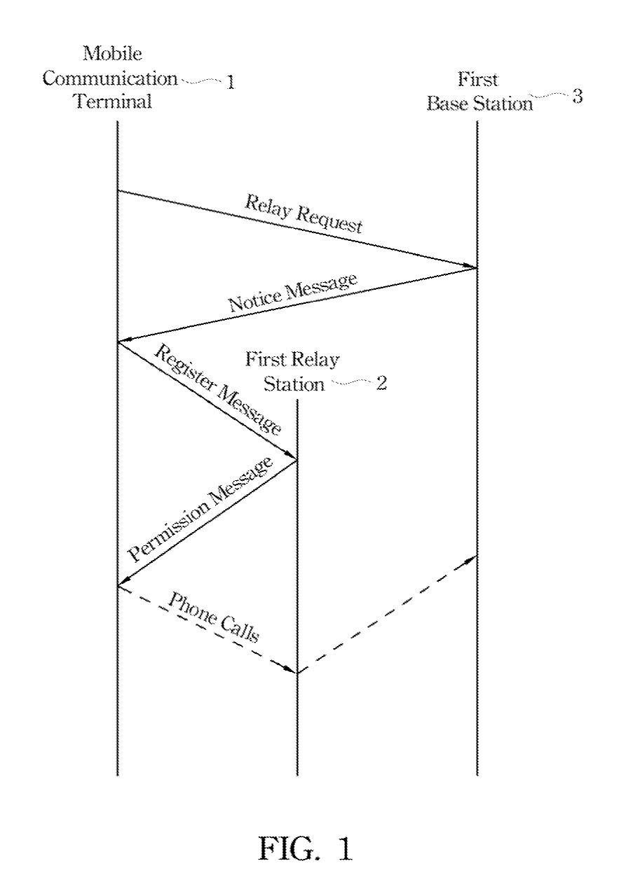

The present invention is a method of using an available mobile communication terminal as a relay station. Such as shown in FIG. 1, the method is applied to a plurality of base stations (BS) and a plurality of mobile communication terminals (a mobile communication terminal 1 is shown as an example) in such as GSM or PHS. Each of the mobile communication terminals has a function of acting as a relay station, i.e. any one of the mobile communication terminals can be used as a relay station. When a mobile communication terminal 1 performs communication, and learns that signals received from a first base station 3 are in a state of being weak (weak signals), the mobile communication terminal 1 sends a relay request to the first base station 3, and requests the first base station 3 to search for at least one other available mobile communication terminal (i.e. not in a communication state) having communication signals stronger than the signals learned to be weak within a coverage area of the first base station 3, i.e. to search for the mobile communication terminals which are performing communication. The mobile communication terminal 1 also requests the first base. station 3 to send out a notice message. After the mobile communication terminal 1 receives the notice message from the first base station 3, another available mobile communication terminal having stronger communication signals is automatically selected as a first relay station 2 (i.e. a base transceiver station (BTS)) within the coverage area of the first base station 3, and a register request is sent to the first relay station 2, thereby requesting a connection between the first relay station 2 and the mobile communication terminal 1. After the first relay station 2 accepts the register request from the mobile communication terminal 1, the mobile communication terminal 1 can be connected to the first base station 3 through the first relay station 2 for performing communication without being affected by a geographic terrain obstacle, such as the dotted arrow lines shown in FIG. 1, thereby effectively overcoming the situation of having an unstable connection or connection failure between the mobile communication terminal 1 and the first base station 3.

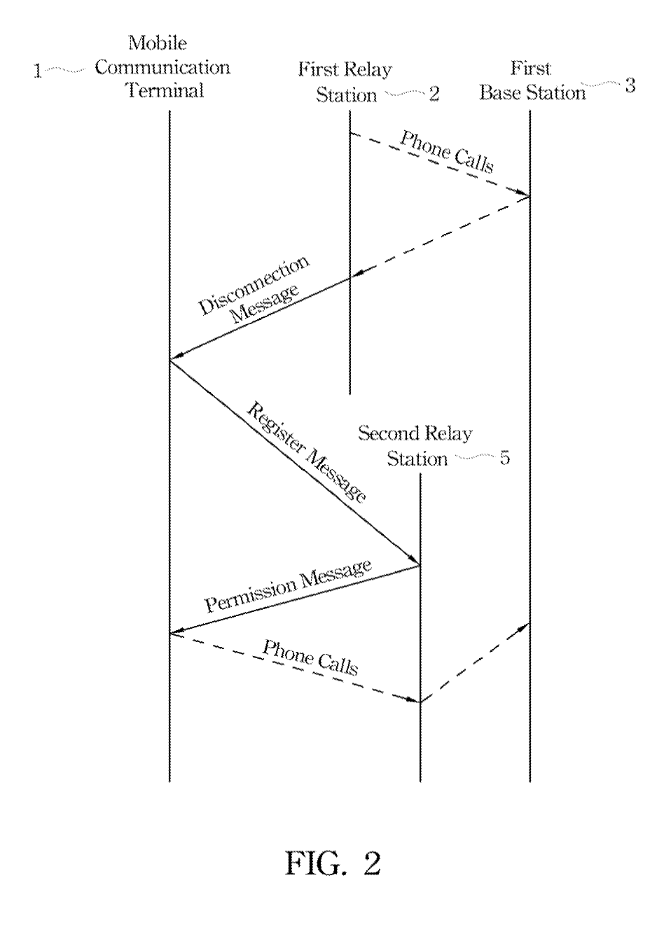

Such as shown in FIG. 2, when the first relay station 2 is desired to receive make phone calls, the connection between the first relay station 2 and the mobile communication terminal 1 has to be disconnected to receive or make phone calls from the first base station 3, such as the dotted arrow lines shown in the upper part of FIG. 2. Thus, the mobile communication terminal 1 cannot connect to the first base station 3. To resolve this problem, in this embodiment, when the first relay station 2 is desired to receive network phone calls or make phone calls, the first relay station 2 promptly sends a disconnection message to the mobile communication terminal 1. Meanwhile, the mobile communication terminal 1 automatically selects a next available mobile communication terminal having stronger communication signals as a second relay station 5 within the coverage area of the first base station 3, thereby connecting to the first base station 3 for making phone calls, such as the dotted arrow lines shown in the upper part of FIG. 2, thus avoiding the problem of the mobile communication terminal 1 failing to connect to the first base station 3.

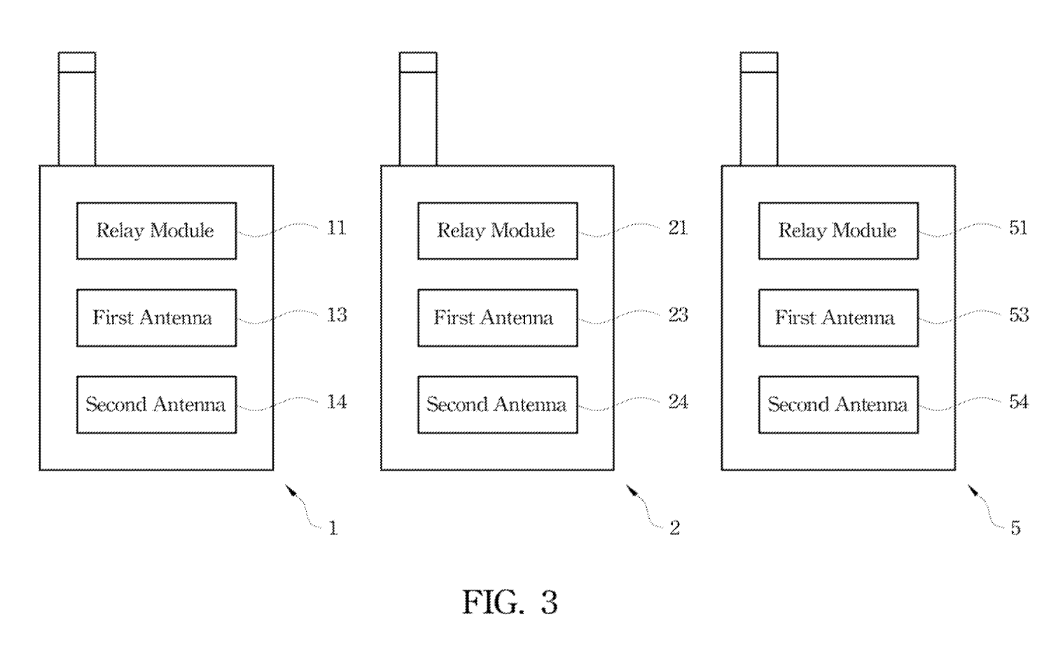

In this embodiment, such as shown in FIG. 2 and FIG. 3, the mobile communication terminal 1 comprises a first antenna 13, a second antenna 14 and a relay module 11, wherein the first antenna 13 of the mobile communication terminal 1 is used to transmit the register request to the first relay station 2, the second antenna 14 of the mobile communication terminal 1 is used to receive and transmit the phone call signals from the first relay station 2 or the first base station 3. The relay module 11 is connected to the first antenna 13 and the second antenna 14 respectively, so that the mobile communication terminal 1 may select another available mobile communication terminal having communication signals stronger than the signals learned to be weak within the coverage area of the first base station 3 through the relay module 11. In this embodiment, the first relay station 2 is a mobile communication terminal with stronger communication signals, and the structure of the first relay station 2 is the same as that of the mobile communication terminal 1. Hence, the first relay station 2 also comprises a first antenna 23, a second antenna 24 and a relay module 21, wherein the first antenna 23 of the lo first relay station 2 is used to receive the register signal from the mobile communication terminal 1, and the second antenna 24 of the first relay station 2 is used to receive and transmit the phone call signals from the mobile communication terminal 1 or the first base station 3. The relay module 21 is connected to the first antenna 23 and the second antenna 24 respectively in the relay station. Therefore, the phone call signals from the mobile communication terminal 1 are transmitted to the second antenna 24 of the first base station 3 through the second antenna 14 of the mobile communication terminal 1 from the relay module 11 of the mobile communication terminal 1, thereby making phone calls.

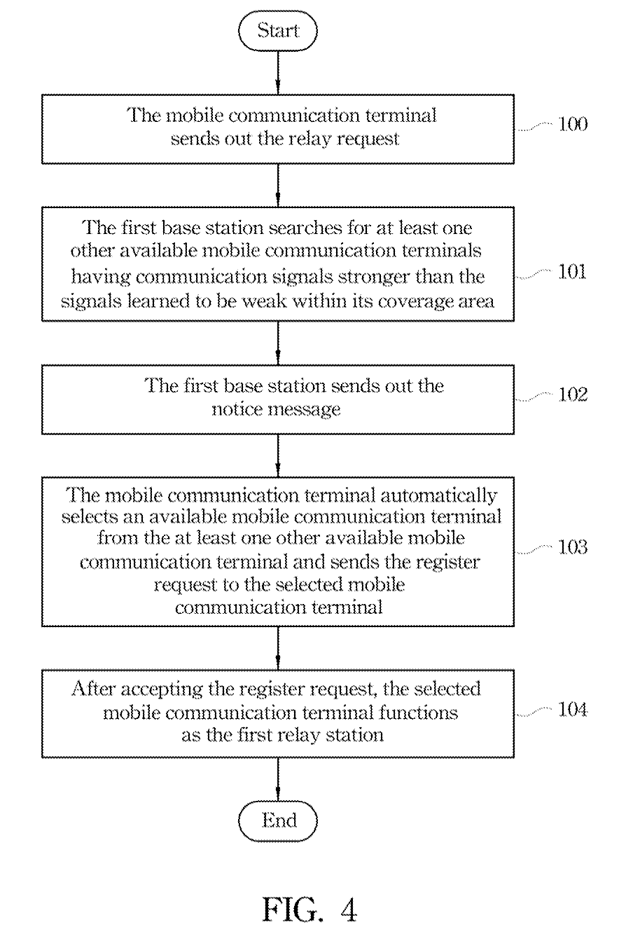

When the mobile communication terminal 1 performs communication and learns that the signals received from the first base station 3 is in a state of being weak, such as shown in FIG. 3 and FIG. 4, the following steps are performed between the mobile communication terminal 1 and the first base station 3 for designating another available mobile communication terminal as a relay station.

In step 100, the mobile communication terminal 1 sends out the relay request from its second antenna 14 to the first base station 3.

In step 101, after receiving the relay request, the first base station 3 searches for at least one other available mobile communication terminal having communication signals stronger than the signals learned to be weak within its coverage area.

In step 102, the first base station 3 sends out the notice message to the second antenna 14 of the mobile communication terminal 1, to inform the mobile communication terminal 1 of the at least one other available mobile to communication terminals found in the coverage area of the first base station 3.

In step 103, the relay module 11 of the mobile communication terminal 1 automatically selects an available mobile communication terminal from the at least one other available mobile communication terminal in accordance with the notice message, and sends the register request to the selected mobile is communication terminal through the first antenna 13 of the mobile communication terminal 1.

In step 104, after accepting the register request, the selected mobile communication terminal functions as the first relay station 2 within the coverage area of the first base station 3. Meanwhile, the relay module 21 of the first relay station 2 generates a permission message, and sends the permission message to the mobile communication terminal 1, to permit the mobile communication terminal 1 to connect with the first relay station 2. Thus, the mobile communication terminal 1 can perform communication by connecting to the first base station 3 through the first relay station 2.

Hence, when the mobile communication terminal 1 is making phone calls and generates phone call signals, the phone call signals are first transmitted to the second antenna 24 of the first relay station 2 through the second antenna 14, and then are transmitted to the first base station 3 from the second antenna 24 of the first relay station 2; and the phone call signals desired to be sent to the mobile communication terminal 1 from the first base station 3 are transmitted through the second antenna 24 of the first relay station 2, thereby allowing the mobile communication terminal 1 to receive the phone call signals.

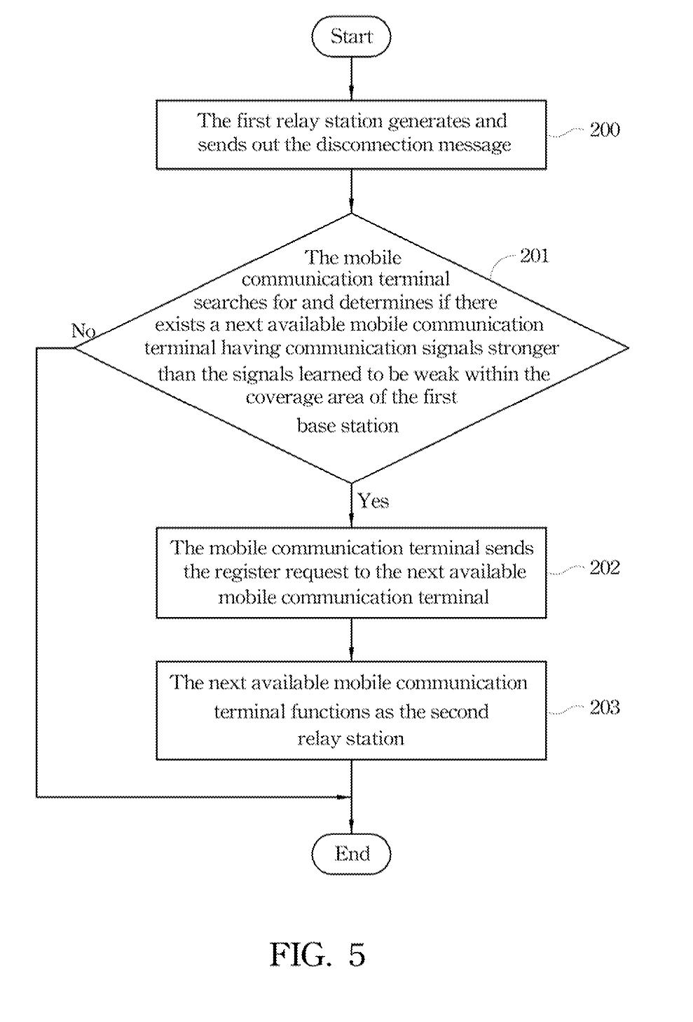

Such as shown in FIG. 3 and FIG. 5, when the first relay station 2 receives or makes phone calls, among the mobile communication terminal 1, the first relay station 2, the first base station 3 and the second relay station 5, the following steps are performed for interrupting the connection between the first relay station 2 and the mobile communication terminal 1 and establishing a connection between the mobile communication terminal 1 and the second relay IS station 5.

In step 200, the first relay station 2 generates the disconnection message, and the disconnection message is sent to the first antenna 13 of the mobile communication terminal 1 through the first antenna 23 of the first relay station 2.

In step 201, after the relay module 11 of the mobile communication terminal 1 receives the disconnection message through the first antenna 13, the mobile communication terminal searches for and determines if there exists a next available mobile communication terminal having communication signals stronger than the signals learned to be weak within the coverage area of the first base station 3. If the result is yes, then step 202 is performed. Otherwise, this procedure is ended.

In step 202, the mobile communication terminal 1 sends another register request to the next available mobile communication terminal having stronger communication signals through the antenna 13.

In step 203, upon accepting the another register request, the next available mobile communication terminal functions as the second relay station 5 within the coverage area of the first base station 3, and then a relay module 51 of the second relay station 5 generates the permission message, and the permission message is sent to the first antenna 13 of the mobile communication terminal 1 through a first antenna 53 of the second relay station 5, so that the mobile communication terminal 1 is permitted to connect to the second relay station 5 and does not connect to the first relay station 2 any more. Meanwhile, the first relay station 2 becomes another available mobile communication terminal, and may start receiving and making phone calls.

Hence, when the mobile communication terminal 1 does not connect to the first relay station 2 any more, the second antenna 14 of the mobile communication terminal 1 may be connected to the first base station 3 through a second antenna 54 of the second relay station 5, thereby continuing to making phone calls, thus avoiding the problem of the mobile communication terminal 1 failing to connect the first base station 3 due to the first relay station 2 receiving and making phone calls

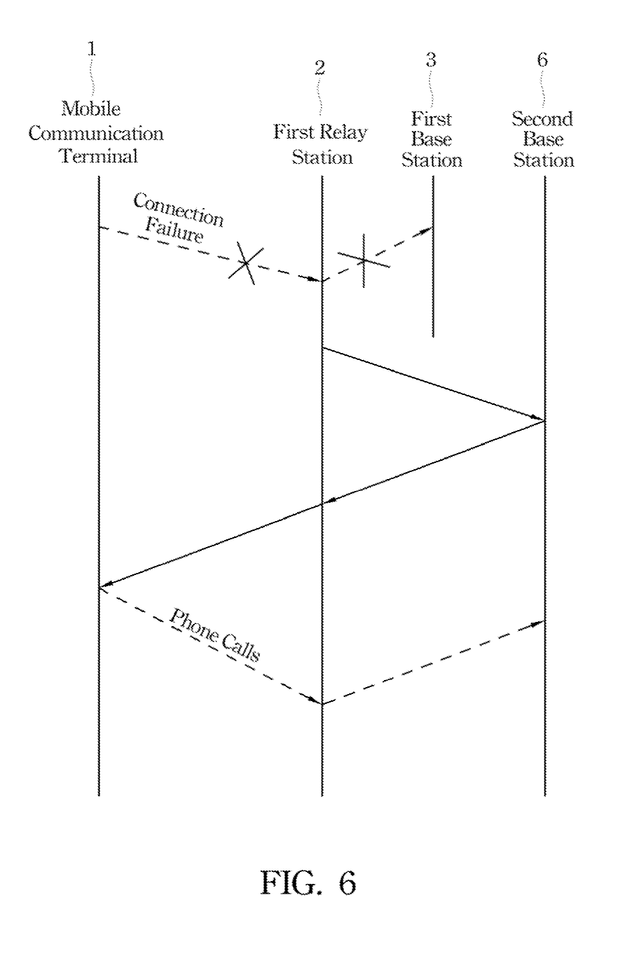

Such as shown in FIG. 6, when the mobile communication terminal 1 and other similar mobile communication terminals transmit a large amount of messages to the first base station 3, the first base station 3 cannot connect to the respective mobile communication terminals within a short period of time since the first base station 3 has to receive the large amount of messages in a short period of time and has reached a maximum communication load. Hence, the mobile communication terminal 1 cannot connect to the first base station 3 through the first relay station 2. In order to resolve this problem, when the mobile communication terminal 1 cannot connect to the first base station 3 through the first relay station 2, the first relay station 2, in the present invention, may search for at least one other available base station, and after receiving the messages sent from the at least one other available base station, the first relay station 2 may automatically select a second base station 6 having stronger communication signals, and meanwhile disconnects the connection with the first base station 3, so that the mobile communication terminal 1 can be connected to the second base station 6 through the first relay station 2, thereby receiving or making phone calls through the second base station 6, thus effectively resolving the short-term network crowded problem for the mobile communication terminal 1.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method of using an available mobile communication terminal as a relay station, applied to a plurality of base stations (BS) and a plurality of mobile communication terminals, each of the mobile communication terminals having a function of acting as a relay station, wherein, when one mobile communication terminal of the mobile communication terminals performs communication and learns that signals received from a first base station are in a state of being weak, the steps of the method among the first base station and the mobile communication terminals comprise:
sending a relay request from the one mobile communication terminal to the first base station for requesting the first base station to search for at least one other available mobile communication terminal of the mobile communication terminals that have communication signals stronger than the signals learned to be weak within a coverage area of the first base station, and requesting the first base station to send out a notice message;
after the one mobile communication terminal receives the notice message from the first base station, automatically selecting an available mobile communication terminal from the at least one other available mobile communication terminal as a first relay station within the coverage area of the first base station, and sending a register request to the first relay station for connecting the first relay station to the one mobile communication terminal; and
after the first relay station accepts the register request from the one mobile communication terminal, the one mobile communication terminal performing communication by connecting to the first base station through the first relay station.

2. The method as claimed in claim 1, wherein, when the first relay station is to receive or make phone calls, the method further comprises the following steps for making the one mobile communication terminal communicate by connecting to the first base station:
sending a disconnection message from the first relay station to the one mobile communication terminal, the disconnection message for disconnecting the first relay station from the one mobile communication terminal;
automatically selecting by the one mobile communication terminal a next available mobile communication terminal from the at least one other available mobile communication terminal as a second relay station within the coverage area of the first base station; and
the one mobile communication terminal performing communication by connecting to the first base station through the second relay station.

3. The method as claimed in claim 1, wherein each of the mobile communication terminals or the relay stations comprises a first antenna, a second antenna and a relay module, and, when the one mobile communication terminal performs communication and learns that the signals received from the first base station are in a state of being weak, the method further comprises the steps of :
sending the relay request from the second antenna of the one mobile communication terminal to the first base station;
after the first base station receives the relay request, searching for the at least one other available mobile communication terminal of the mobile communication terminals that has communication signals stronger than the signals learned to be weak within the coverage area of the first base station;
sending the notice message from the first base station to the second antenna of the one mobile communication terminal, to inform the one mobile communication terminal of the at least one other available mobile communication terminal found in the coverage area of the first base station;
automatically selecting, by the relay module of the one mobile communication terminal, the available mobile communication terminal to be the first relay station in accordance with the notice message, and sending the register request to the available mobile communication terminal through the first antenna of the one mobile communication terminal; and
upon accepting the register request, the available mobile communication terminal functioning as the first relay station within the coverage area of the first base station, and generating a permission message by the relay module of the first relay station, and sending the permission message to the one mobile communication terminal to permit the one mobile communication terminal to connect with the first relay station, so that the one mobile communication terminal connects to the first base station through the first relay station.

4. The method as claimed in claim 1, wherein, when the first relay station is to receive or make phone calls, among the one mobile communication terminal, the first relay station, the first base station and the second relay station, the steps for disconnecting the first relay station from the one mobile communication terminal and connecting the one mobile communication terminal to the second relay station comprises:
the first relay station generating the disconnection message through the relay module of the first relay station, and sending the disconnection message to the first antenna of the one mobile communication terminal through the first antenna of the first relay station;
after the relay module of the one mobile communication terminal receives the disconnection message through the first antenna of the one mobile communication terminal, searching for and selecting the next available mobile communication terminal of the at least one other available mobile communication terminal as the second relay station in the coverage area;
sending another register request to the next available mobile communication terminal through the first antenna of the one mobile communication terminal; and
Upon accepting the another register request, generating another permission message by the relay module of the next available mobile communication terminal to permit the one mobile communication terminal to connect with the next available mobile communication terminal, so that the one mobile communication terminal connects to the first base station through the second relay station.

5. The method as claimed in claim 4, wherein, when the next available mobile communication terminal of said at least one other available mobile communication terminal is not found within the coverage area that has communication signals stronger than the signals learned to be weak, the relay module of the one mobile communication terminal stops connecting to the first base station.

6. The method as claimed in claim 1, wherein, when the one mobile communication terminal fails to connect to the first base station through the first relay station, the method further comprises the steps of:
searching for at least one other available base station by the first relay station; and
after the first relay station receives messages from the at least one other available base station, automatically selecting a second base station from the at least one other available base station, and meanwhile, disconnecting the first relay station from the first base station and connecting the one mobile communication terminal to the second base station through the first relay station.
